(19) United States
(12) Patent Application Publication
(10) Pub. No.: US 2024/0354892 A1
(43) Pub. Date: Oct. 24, 2024

(54) INFORMATION PROCESSING APPARATUS, INFORMATION PROCESSING METHOD, AND STORAGE MEDIUM FOR GENERATING PROCESSED IMAGES DIFFERENT IN RESOLUTION

(71) Applicant: CANON KABUSHIKI KAISHA, Tokyo (JP)

(72) Inventors: SHOICHI HOSHINO, Tokyo (JP); ATSUSHI NOGAMI, Kanagawa (JP)

(21) Appl. No.: 18/635,392

(22) Filed: Apr. 15, 2024

(30) Foreign Application Priority Data
Apr. 24, 2023 (JP) 2023-070796

(51) Int. Cl. G06T 3/40; G06T 7/00; G06T 7/11; G06V 10/764

(52) U.S. Cl. CPC G06T 3/40; G06T 7/0002; G06T 7/11; G06V 10/764; G06T 2207/20021; G06T 2207/20081; G06T 2207/30184

(57) ABSTRACT

An information processing apparatus includes one or more memories storing instructions, and one or more processors executing the instructions to generate a plurality of processed images different in resolution, from a target image, set a type of an object included in the target image and select, as an image to be used for specifying the object of the type that has been set, from the plurality of processed images, a processed image of a resolution corresponding to the type of the object that has been set.

### BACKGROUND

### Field

The present disclosure relates to an information processing apparatus, an information processing method, and a storage medium.

### Description of the Related Art

In recent years, image inspection using an image obtained by imaging a wall surface of the structure is performed as an example of a method of inspecting a concrete structure such as a bridge and a tunnel. In the image inspection, a method of detecting a defect such as a crack by performing image recognition processing on an image obtained by imaging an inspection object has been proposed (Ji Dang et al., “Multi-Type Bridge Damage Detection Method Based on YOLO”, Artificial Intelligence and Data Science, Vol. 2, No. J2, pp. 447-456 (2021)), and the defect can be efficiently detected by using such a technique.

On the other hand, a defect detection result generated using image recognition processing and image analysis processing may include erroneous detection and non-detection in some cases. Thus, an inspection worker checks and corrects the defect detection result while viewing an image of an inspection object by performing display operation such as enlargement and reduction. Further, to reduce erroneous detection and non-detection, the defect detection result may be used for training in some cases. Japanese Patent Application Laid-Open No. 2008-46065 discusses a method of adjusting a defect detection result based on a reduction scale factor of an image and superimposing the adjusted defect detection result on an inspection image.

There are various types of defects to be detected, and depending on the type, the defect can be checked only in a high-resolution image. In the existing technique, imaging is performed so as to detect the defect that can be checked only in the high-resolution image, which increases the amount of image data.

In a case where the amount of the image data is large as described above, a readout load is increased and so much storage space is taken up in order to display the image data for a checking operation and hold the image data as training data.

### SUMMARY

According to an aspect of the present disclosure, an information processing apparatus includes one or more memories storing instructions, and one or more processors executing the instructions to generate a plurality of processed images different in resolution, from a target image, set a type of an object included in the target image and select, as an image to be used for specifying the object of the type that has been set, from the plurality of processed images, a processed image of a resolution corresponding to the type of the object that has been set.

Further features of the present disclosure will become apparent from the following description of exemplary embodiments with reference to the attached drawings.

### BRIEF DESCRIPTION OF THE DRAWINGS

FIGS. 1A to 1E are diagrams illustrating an outline of a first exemplary embodiment.

FIGS. 2A and 2B are block diagrams illustrating a configuration example of an information processing apparatus according to the first exemplary embodiment.

FIGS. 3A to 3C are diagrams illustrating images to be processed and association of defect data and a drawing.

FIG. 4 is a flowchart illustrating an example of a processing procedure according to the first exemplary embodiment.

FIGS. 5A to 5D are diagrams illustrating processing for creating images different in resolution.

FIGS. 6A and 6B are diagrams illustrating processing for setting a label type.

FIGS. 7A to 7C are diagrams illustrating processing for acquiring label data.

FIGS. 8A to 8E are diagrams illustrating processing for selecting a process image depending on the label type.

FIGS. 9A to 9F are diagrams illustrating processing for creating display data and displaying a display screen.

FIG. 10 is a block diagram illustrating a functional configuration example of an information processing apparatus according to a second exemplary embodiment.

FIG. 11 is a flowchart illustrating an example of a processing procedure according to the second exemplary embodiment.

FIGS. 12A to 12E are diagrams illustrating processing for acquiring label data to be trained.

FIGS. 13A to 13E are diagrams illustrating processing for selecting a process image depending on a label type.

FIGS. 14A to 14C are diagrams illustrating processing for collecting training data.

### DESCRIPTION OF THE EMBODIMENTS

Some exemplary embodiments of the present disclosure are described in detail below with reference to accompanying drawings. Note that the following exemplary embodiments do not limit the present disclosure. A plurality of features is described in the exemplary embodiments, but all of the plurality of features are not necessarily essential for the disclosure, and the plurality of features may be optionally combined.

In the following, an information processing apparatus used for inspection of an infrastructure such as a concrete structure is described. A first exemplary embodiment discusses an example in which, when an image obtained by imaging an inspection object and a defect detected from the image are displayed, a relatively low resolution image can be selected and displayed based on a type of the defect.

In the present exemplary embodiment, the term “inspection object” means a concrete structure to be inspected, such as a limited-access road for automobiles, a bridge, a tunnel, and a dam. The information processing apparatus performs defect detection processing for detecting presence/absence and a state of a defect such as a crack by using an image that a user obtains by imaging an inspection object. For example, in a case of the concrete structure, the term “defect” means crack, delamination, and flaking or scaling of concrete. The term “defect” also means efflorescence, reinforcing bar exposure, rust, water leakage, water dripping, corrosion, damage (partial missing), cold joint, deposit, and rock pocket.

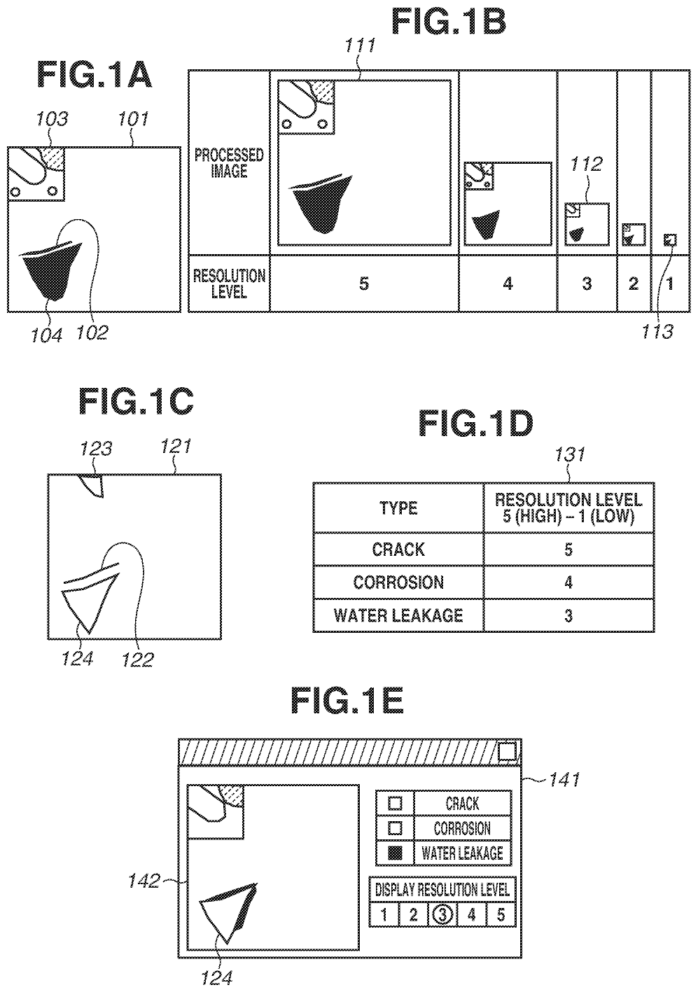

First, an outline of the present exemplary embodiment is described. FIG. 1A is a diagram illustrating an example of an image 101 obtained by imaging a wall surface of a bridge, as an example of an inspection object. The image obtained by imaging the inspection object (target image) 101 includes a crack 102, corrosion 103, and water leakage 104. In defect detection processing, defect data on a detection result including a position and a shape of a defect is generated from the image 101 to be processed, and is recorded in association with the image 101 to be processed. As a method of creating the defect data, for example, there is a method of acquiring the defect data by detecting a defect from an image by using a trained model generated by machine learning or deep learning by artificial intelligence (AI).

Thereafter, an inspection worker performs a work for checking the image to determine whether the position and the shape of the defect in the generated defect data are correct. At this time, a readout load of the image is increased as the image has a large size.

In a case where an information processing apparatus for checking the image and an information processing apparatus for managing the image and the defect data are separately provided, a data communication load is higher as the image has a larger size. In particular, in a case of the infrastructure, to detect a defect such as a minute crack occurring in a structure in a scale of several tens of meters, a high-definition image having a large size is used. Therefore, the readout load of the image and the data communication load to check presence/absence of a defect become considerably high.

Thus, in the present exemplary embodiment, an image of a suitable resolution is selected and displayed based on a defect type to be checked. The information processing apparatus according to the present exemplary embodiment prepares a plurality of images different in resolution based on an original image, and selects and displays an image of a suitable resolution based on the defect type to be checked. As a method of creating the plurality of images different in resolution, for example, there is a method of repeatedly performing processing for reducing the original image at a constant rate.

FIG. 1B is a diagram illustrating an example of images different in resolution generated from the image 101 to be processed, and illustrates images different in resolution generated by repeatedly performing processing for reducing an image size to a half size. An image 111 of the highest resolution corresponds to a resolution level 5, and an image 113 of the lowest resolution corresponds to a resolution level 1.

FIG. 1C is a diagram illustrating an example of defect data 121 detected from the image 101 to be processed. The defect data 121 includes three types of defect data: crack data 122, corrosion data 123, and water leakage data 124.

In the present exemplary embodiment, a suitable image is selected from the images illustrated in FIG. 1B based on a resolution level list 131 by defect type as illustrated in FIG. 1D. For example, in a case where “water leakage” is selected as a defect type to be checked, an image 112 corresponding to a resolution level 3 is selected based on the resolution level list 131. Thereafter, display data is generated using the water leakage data 124 to be checked and the selected image 112.

FIG. 1E is a diagram illustrating an example of a display screen 141. A display image 142 on the display screen 141 is a display image generated based on the image 112 and the water leakage data 124. In the display image 142, the crack 102 present in the image 101 to be processed cannot be visually specified, but the water leakage 104 to be checked can be visually specified. As described above, by selecting the image of the suitable resolution based on the defect type, it is possible to reduce the image readout load while maintaining a state where the defect to be checked can be visually recognized. In addition, in the case where the information processing apparatus for checking the image and the information processing apparatus for managing the image and the defect data are separately provided, the data communication load can also be reduced.

### <Hardware Configuration>

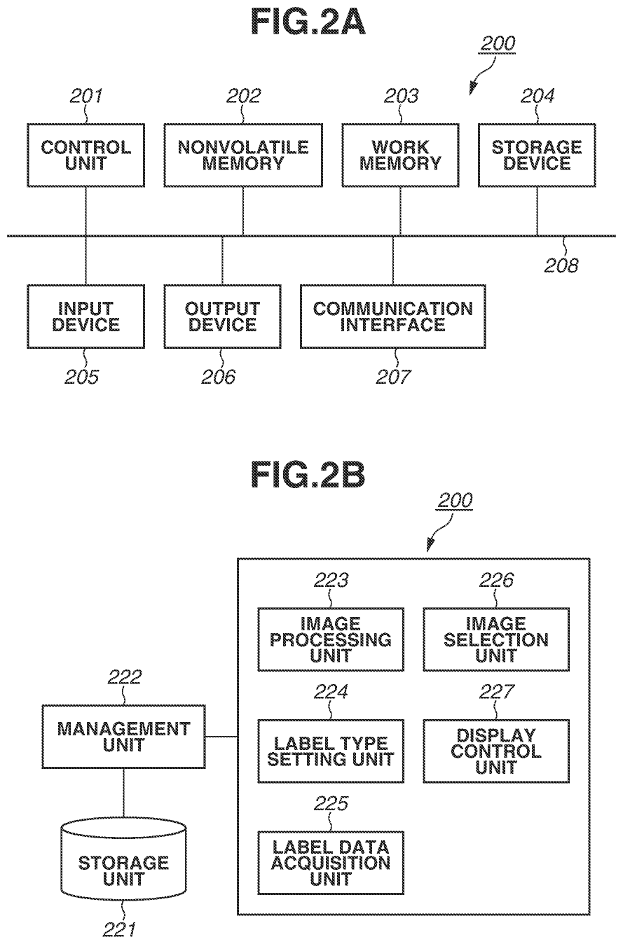

FIG. 2A is a block diagram illustrating a hardware configuration example of an information processing apparatus 200 according to the present exemplary embodiment. In the present exemplary embodiment, processing of the information processing apparatus 200 may be implemented by a single computer apparatus, or may be implemented by distributing functions to a plurality of computer apparatuses as appropriate. In this case, the plurality of computer apparatuses is to be communicably connected to one another.

The information processing apparatus 200 includes a control unit 201, a nonvolatile memory 202, a work memory 203, a storage device 204, an input device 205, an output device 206, a communication interface 207, and a system bus 208.

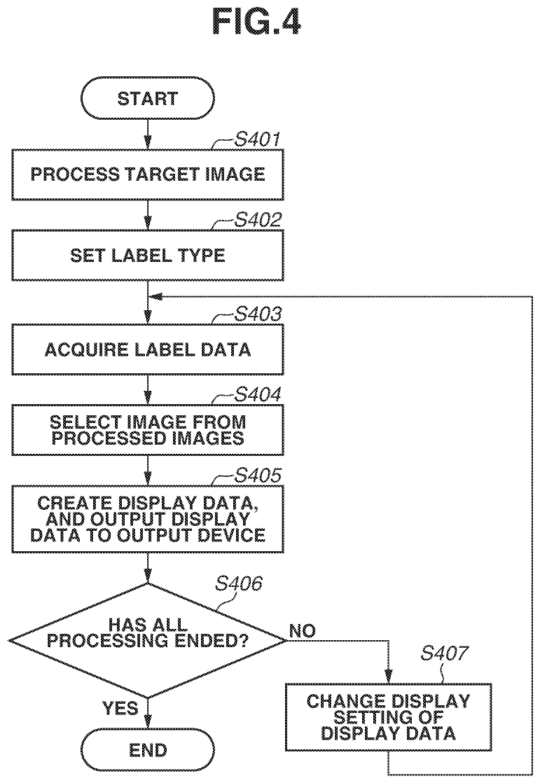

The control unit 201 includes a calculation processor totally controlling the whole of the information processing apparatus 200, such as a central processing unit (CPU) and a micro-processing unit (MPU). The nonvolatile memory 202 is a read only memory (ROM) storing programs to be executed by the processor of the control unit 201, and parameters. The programs indicate programs for executing processing according to each of the exemplary embodiments described below. The nonvolatile memory 202 stores an operating system (OS) that is basic software executed by the control unit 201, and applications for implementing applied functions in cooperation with the OS. The work memory 203 is a random access memory (RAM) temporarily storing programs and data supplied from an external apparatus and the like. The work memory 203 also holds data obtained by executing control processing in FIG. 4 described below.

The storage device 204 is an internal device incorporated in the information processing apparatus 200, such as a hard disk and a memory card, or an external device attachable to and detachable from the information processing apparatus 200, such as a hard disk and a memory card. The storage device 204 includes a memory card and a hard disk configured by a semiconductor memory, a magnetic disk, and the like. The storage device 204 also includes a storage medium configured by a disc drive that reads and writes data from/to an optical disc such as a digital versatile disc (DVD) and a Blu-ray Disc.

The input device 205 is an operation member for receiving user operations, such as a mouse, a keyboard, and a touch panel, and the input device 205 outputs an operation instruction to the control unit 201. The output device 206 is a display device configured by a liquid crystal display (LCD) or an organic electroluminescence (EL), such as a display and a monitor, and the output device 206 displays data held by the information processing apparatus 200 and data supplied from an external apparatus. The communication interface 207 is communicably connected to a network such as the Internet and a local area network (LAN). The system bus 208 includes an address bus, a data bus, and a control bus that connect the components of the information processing apparatus 200 such that data can be exchanged between the components.

In the present exemplary embodiment, the nonvolatile memory 202 stores applications for implementing the control processing described below. The control processing of the information processing apparatus 200 according to the present exemplary embodiment is implemented by reading out software provided by the applications. The applications include software for using basic functions of the OS installed in the information processing apparatus 200. The OS of the information processing apparatus 200 may include software for implementing the control processing according to the present exemplary embodiment.

### <Functional Blocks>

FIG. 2B is a block diagram illustrating a functional configuration example of the information processing apparatus 200 according to the present exemplary embodiment. The information processing apparatus 200 includes a storage unit 221, a management unit 222, an image processing unit 223, a label type setting unit 224, a label data acquisition unit 225, an image selection unit 226, and a display control unit 227. The functional units of the information processing apparatus are configured by hardware and/or software. Each of the functional units may be configured by one or a plurality of computer apparatuses or server apparatuses, and may be configured as a system connected by a network. In a case where each of the functional units illustrated in FIG. 2B is configured by hardware in place of software, a circuit configuration corresponding to each of the functional units illustrated in FIG. 2B may be provided.

The management unit 222 manages registration, deletion, acquisition, update, and the like of image data to be processed and defect data stored in the storage unit 221. The image processing unit 223 processes the image data to generate a processed image. The label type setting unit 224 sets a label type. The label data acquisition unit 225 acquires label data to be displayed. The image selection unit 226 selects an image from processed images based on the label type. The display control unit 227 generates display data by using the selected image and the acquired label data, outputs the display data to the output device 206, and causes the output device 206 to display the display data. Details of the processing and the functions of the image processing unit 223, the label type setting unit 224, the label data acquisition unit 225, the image selection unit 226, and the display control unit 227 are described below with reference to FIG. 4.

### <Description of Images and Defect Data>

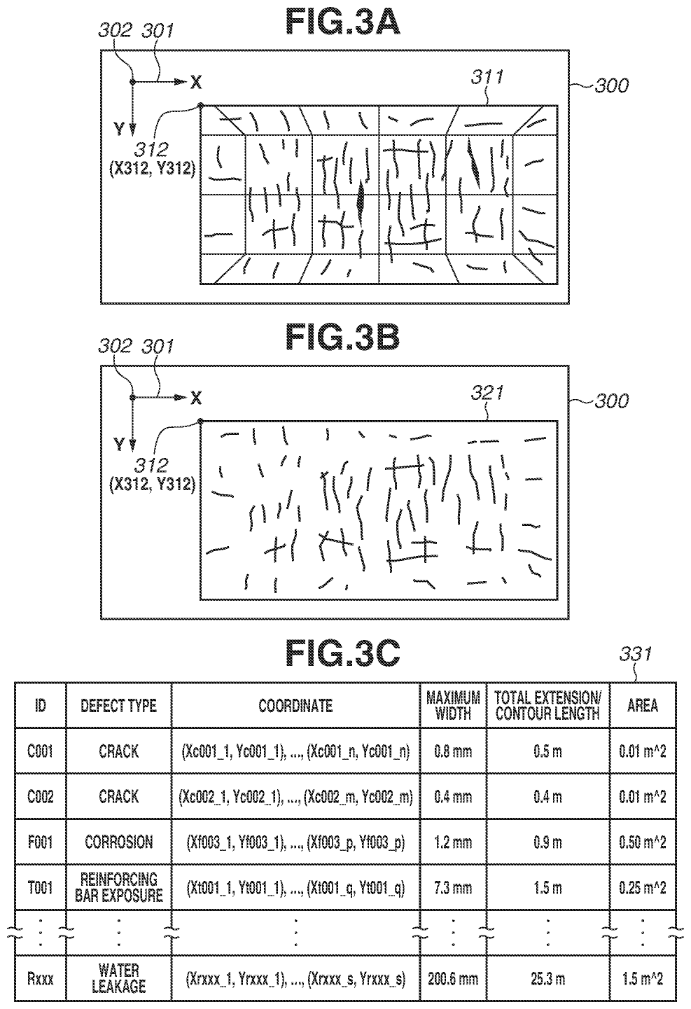

Next, an image and defect data used for the control processing of the information processing apparatus 200 according to the present exemplary embodiment are described with reference to FIGS. 3A to 3C. In image inspection, an image obtained by imaging a wall surface of a bridge as a structure is managed in association with a drawing. FIG. 3A is a diagram illustrating a state where an image 311 obtained by imaging a wall surface of a bridge as an example of an infrastructure is attached to a drawing 300. The drawing 300 includes drawing coordinates 301 with a point 302 as an origin. A position of an image on the drawing is defined by vertex coordinates at an upper-left corner of the image. For example, the coordinates of the image 311 is located at a position (X312, Y312) of a vertex 312. The image is stored together with the coordinate information in the storage unit 221.

In the present exemplary embodiment, the image used for image inspection of an infrastructure has a large image size because the image is captured at a high resolution (e.g., 1 mm per one pixel) in order to enable check of a minute crack and the like. For example, the image 311 in FIG. 3A is an image obtained by imaging a floor slab of a bridge having a size of 20 m×10 m. In a case where the resolution is 1.0 mm per one pixel (1.0 mm/pixel), the image size of the image 311 is 20,000 pixels×10,000 pixels. The image 311 captured at a high resolution includes defects with various sizes, such as a crack, reinforcing bar exposure, corrosion, water leakage, and efflorescence. The defect data is information on an automatic detection result of a defect such as a crack occurring on a concrete wall surface, or information that is updated based on a detection result by human operation. In the present exemplary embodiment, the defect data is managed in association with the drawing.

FIG. 3B is a diagram illustrating a state where defect data 321 corresponding to the image 311 illustrated in FIG. 3A is attached to the position same as the position of the image 311 in the drawing 300. The defect data 321 includes a large number of defects, and positions on the drawing of the defects in the defect data 321 are defined by pixel coordinates forming the defect data.

FIG. 3C is a diagram illustrating an example of a defect data table 331. In the defect data table 331, a coordinate column indicates attribute values representing a plurality of coordinates forming the defect data. For example, a crack having an identification (ID) “C001” is represented by continuous pixels at n points (Xc001_1, Yc001_1) to (Xc001_n, Yc001_n). As described above, in the present exemplary embodiment, the defect data is represented by pixels. The defect data may be represented by vector data such as a polyline and a curve including a plurality of points. In a case where the defect data is represented by vector data, a data capacity is reduced, and the defect data is more simply represented. As an example of the defect data other than a crack, corrosion having an ID “F001” is present. In a case where corrosion is represented by a polyline, a region surrounded by polylines indicates a defect area. The attribute information held by the defect data is not limited to the attribute information illustrated in the defect data table 331, and the defect data may hold other attribute information.

In the control processing of the information processing apparatus 200 according to the present exemplary embodiment, the image and the defect data are associated with each other, which makes it possible determine a positional relationship between the defect data and the image without using the drawing.

### <Control Processing>

FIG. 4 is a flowchart illustrating an example of a processing procedure executed by the information processing apparatus 200 according to the present exemplary embodiment. The processing illustrated in FIG. 4 is implemented when the control unit 201 operates as the functional units illustrated in FIG. 2B by loading the programs stored in the nonvolatile memory 202 to the work memory 203 and executing the programs. In the following, the processing according to the present exemplary embodiment is described with reference to the flowchart illustrated in FIG. 4.

### <Step S401: Image Process>

In step S401, the image processing unit 223 processes a target image, to generate processed images. In the present exemplary embodiment, as a method of processing the image, a method of converting a resolution to generate images different in resolution as processed images is described.

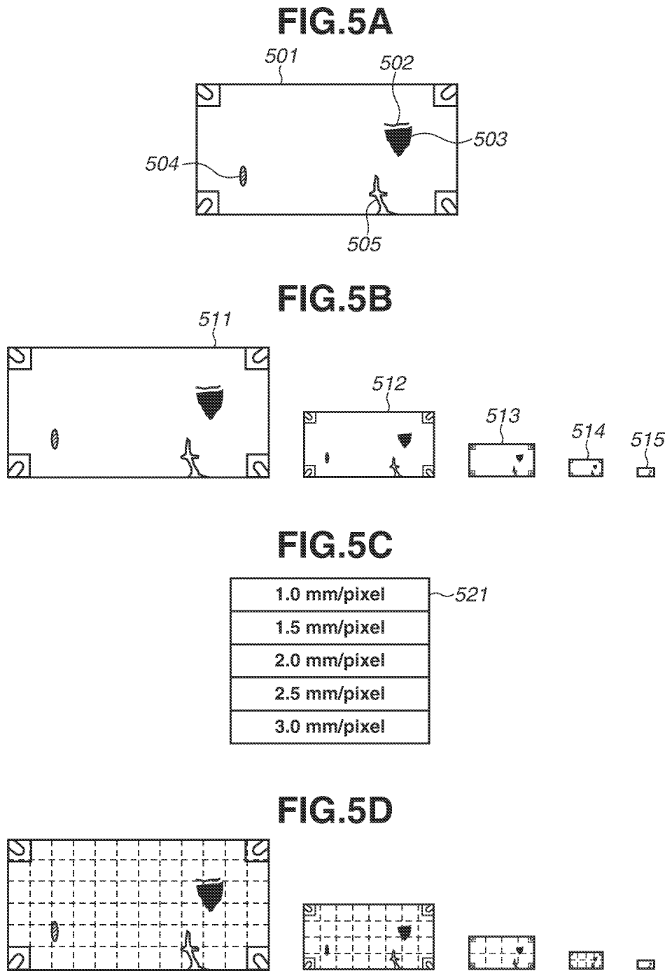

An image 501 illustrated in FIG. 5A is an example of an image obtained by imaging a concrete wall surface of a bridge. The image 501 is an image having an extremely large image size of 20,000 pixels×10,000 pixels. The image 501 includes a crack 502, water leakage 503, reinforcing bar exposure 504, and efflorescence 505. In the present exemplary embodiment, to generate images different in resolution from the image 501, resolution conversion processing for reducing the image size at a constant rate is repeated.

FIG. 5B is a diagram illustrating an example of images 511 to 515 different in resolution generated by repeatedly performing the same reduction processing on the image 501. In the example illustrated in FIG. 5B, the images different in resolution are generated in five different levels; however, the images different in resolution may be generated in six or more levels or in four or less levels. As another method of converting the resolution, a method of using a real value of the resolution may be used.

First, the image processing unit 223 acquires the target image, and information on the resolution (e.g., 0.5 mm/pixel) of the image. Thereafter, the image processing unit 223 performs the resolution conversion processing on the target image, so as to obtain predetermined target resolutions 521 illustrated in FIG. 5C. As a result, a plurality of images having designated resolutions can be generated as the processed images.

As another method of processing the image, the resolution conversion processing and image dividing processing may be combined. FIG. 5D is a diagram illustrating a result obtained by repeatedly performing the reduction processing on the target image, to generate the processed images, and then performing the image dividing processing on the processed images at a predetermined division size. Dotted lines in each of the images illustrated in FIG. 5D indicate boundaries of divisions. Alternatively, as the method of the image dividing processing, a file use may be used. The image dividing processing is performed by determining the division size such that, for example, a file size of one divided image becomes less than a fixed reference value (e.g., 100 KB). At this time, in a case where the file size of the image before the division is less than the reference value, the image dividing processing is omitted. In this manner, the image dividing processing can be performed using the file size per one divided image.

### <Step S402: Label Type Setting Process>

In step S402, the label type setting unit 224 performs processing for setting a label type. In the present exemplary embodiment, among the detected defects, a defect type to be checked is set as the label type. As a method of setting the label type, for example, a method of setting a defect type to be detected, as the label type can be used.

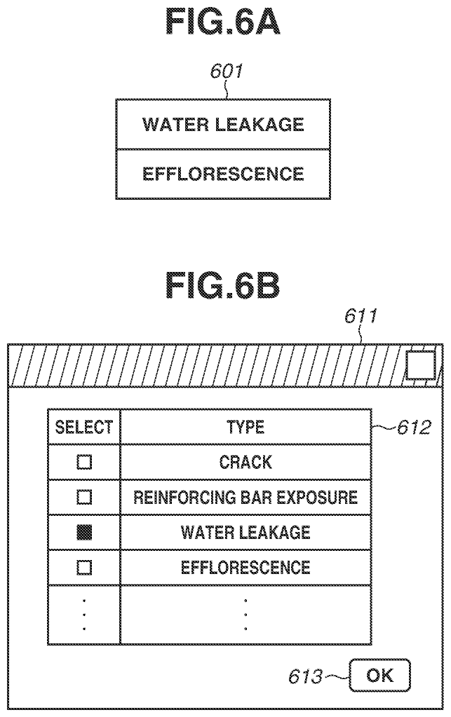

FIG. 6A is a diagram illustrating an example of defect types 601, detection processing of which has been performed on the target image. In a case where the defect types 601 illustrated in FIG. 6A are obtained as results of the detection processing, the label type setting unit 224 sets “water leakage” and “efflorescence” as the label types. In the present exemplary embodiment, information on the defect types, the detection processing of which has been performed, are stored in the storage unit 221, and the label type setting unit 224 can acquire the information on the defect types, the detection processing of which has been performed, via the management unit 222.

As another method of setting the label type, the display control unit 227 may first display a screen for receiving a user operation on the output device 206, and the label type may be set in response to a user operation instruction. FIG. 6B is a diagram illustrating an example of a screen 611 for receiving input of a label type. In the screen 611, a defect type list 612 is displayed, and “water leakage” in the defect type list 612 is selected by the user operation. Thereafter, in response to an operation on an OK button 613, the selected “water leakage” is set as the label type. As described above, the label type can be set in response to the user operation instruction.

### <Step S403: Label Data Acquisition Process>

In step S403, the label data acquisition unit 225 performs processing for acquiring label data. In the present exemplary embodiment, the label data acquisition unit 225 acquires a part or all of defect data relating to the target image, which is stored in the storage unit 221, as the label data via the management unit 222.

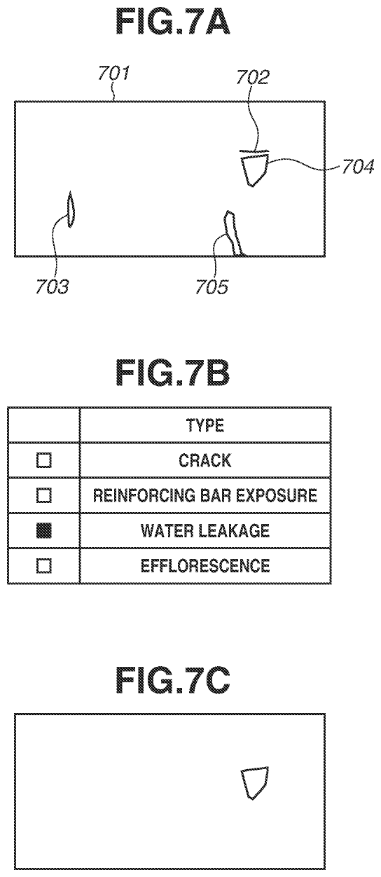

FIG. 7A illustrates an example of defect data 701. The defect data 701 includes crack data 702, reinforcing bar exposure data 703, water leakage data 704, and efflorescence data 705. The label data acquisition unit 225 acquires, as the label data, defect data corresponding to the detection result related to the set label type from the defect data 701. For example, in a case where “water leakage” is selected as the label type as illustrated in FIG. 7B, the label data acquisition unit 225 acquires the water leakage data 704 as the label data from the defect data 701. FIG. 7C illustrates an example of an acquisition result.

In the label data acquisition processing, a screen for receiving a user operation instruction may be displayed to allow the user to select label data to be acquired. The user may be allowed to select a label type or a part of label data.

The defect data on all detection results relating to the target image can be acquired as the label data. In a case where no defect detection result relating to the target image is present or in a case where the defect detection result is not displayed, the step may be skipped. In a case where the step is skipped, the display data is generated based on the image selected by the image selection unit 226, and the display data is output to the output device 206.

### <Step S404: Image Selection Process>

In step S404, the image selection unit 226 performs processing for selecting an image from the processed images based on the label type. In the present exemplary embodiment, a method of selecting, based on the label type, the image of the suitable resolution from the images different in resolution generated in step S401 is described.

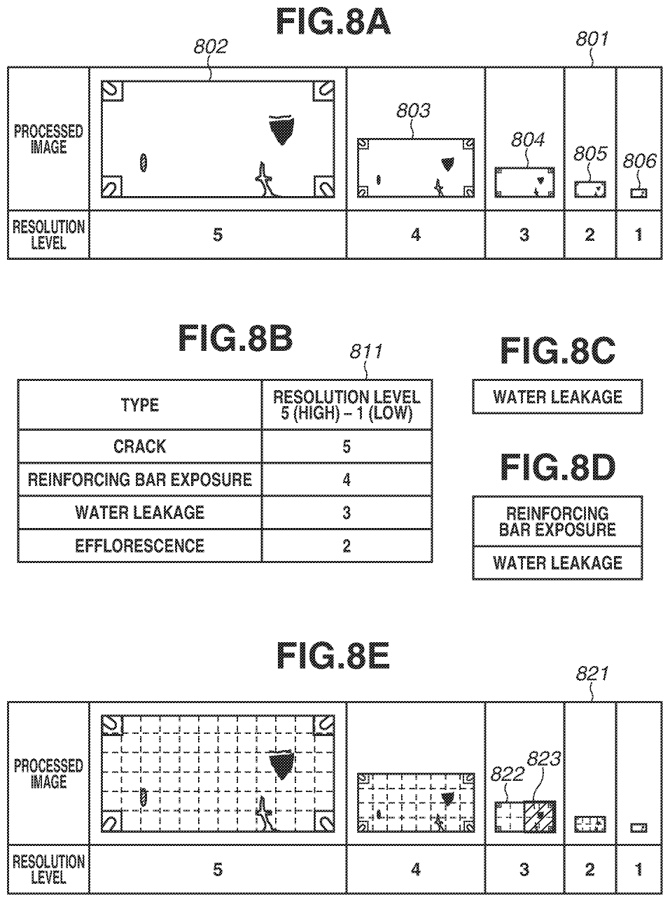

FIG. 8A is a diagram illustrating an example of processed images 801 generated in step S401. The image selection unit 226 selects the image of the suitable resolution from the processed images 801 by using a resolution level list 811 indicated by label type illustrated in FIG. 8B. The resolution level list 811 defines resolution levels 5 to 1 for the label types, and the resolution levels 5 to 1 respectively correspond to processed images 802 to 806. In a case where “water leakage” is set as the label type in step S402 as illustrated in FIG. 8C, the image selection unit 226 selects the processed image 804 corresponding to the resolution level 3 because “water leakage” is associated with the resolution level 3 in the resolution level list 811. In the above-described manner, the image of the suitable resolution is selected based on the label type.

In a case where a plurality of label types is set in step S402, the image of the suitable resolution can also be selected. For example, in a case where “reinforcing bar exposure” and “water leakage” are set as the label types in step S402 as illustrated in FIG. 8D, “reinforcing bar exposure” is associated with the resolution level 4, and “water leakage” is associated with the resolution level 3 in the resolution level list 811. The image selection unit 226 selects the processed image 803 as an image corresponding to the highest resolution level 4 between the resolution levels of the set label types. In this manner, in the case where the plurality of label types is set, the image of the resolution corresponding to the highest resolution level is selected.

In a case where the image dividing processing is also performed in step S401, the label type and a display range may be combined. FIG. 8E is a diagram illustrating an example of processed images 821 subjected to the image dividing processing in step S401. First, the resolution level corresponding to the label type is selected. For example, in a case where “water leakage” is selected as the label type, the image selection unit 226 selects a partial image (e.g., partial image 823) corresponding to a display range of the defect from a processed image 822 corresponding to the resolution level 3. As described above, a partial image of the processed image can be selected based on the label type and the defect display range.

### <Step S405: Display Process>

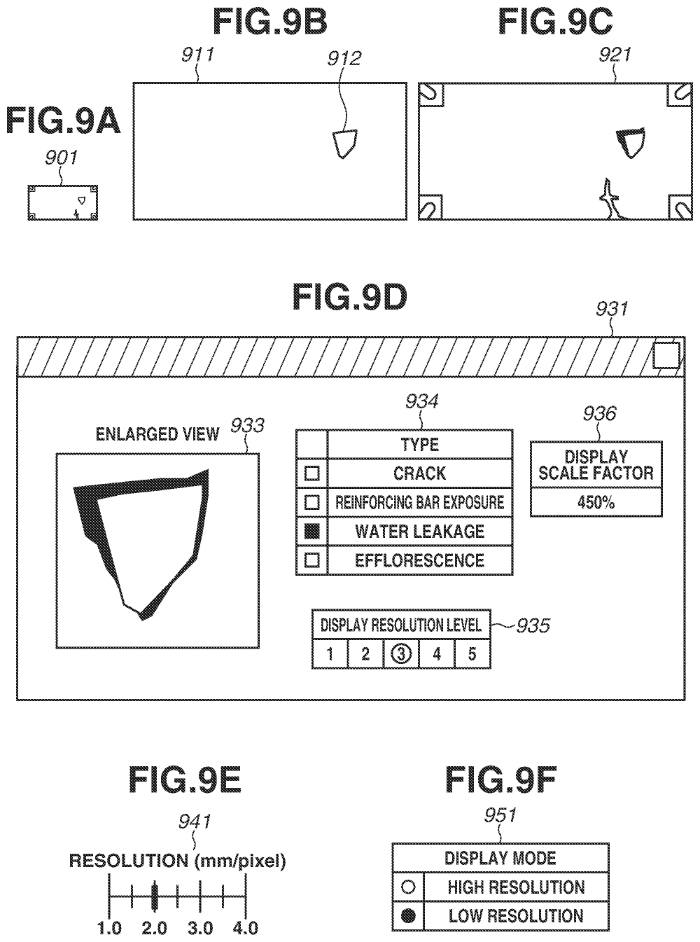

In step S405, the display control unit 227 performs processing for creating display data by using the processed image selected in step S404 and the label data acquired in step S403, and outputting the display data to the output device 206. In the following, the processing performed by the display control unit 227 is described with reference to FIGS. 9A to 9F.

FIG. 9A is a diagram illustrating an example of a processed image 901 selected by the image selection unit 226 in step S404. The processed image 901 is an image generated by repeatedly performing the reduction processing on the image of the inspection object (to be processed) in step S401. FIG. 9B is a diagram illustrating an example of label data 911 acquired by the label data acquisition unit 225 in step S403. The label data 911 is label data corresponding to the target image, and includes water leakage data 912. The display control unit 227 performs processing for superimposing the processed image 901 and the label data 911 to generate superimposition data. In the present exemplary embodiment, as illustrated in FIGS. 3A to 3C, each of the target image and the label data has the coordinate values in the drawing coordinate system. Therefore, coordinate values of the processed image 901 generated based on the target image can also be indirectly determined. Thus, the superimposition data can be generated by superimposing the processed image 901 and the label data 911 after adjusting scales and positional relationship of the processed image 901 and the label data 911. FIG. 9C illustrates an example of superimposition data 921 generated using the processed image 901 and the label data 911.

After creating the superimposition data, the display control unit 227 performs processing for creating the display data to be displayed on the output device 206 by using the superimposition data, and outputting the display data to the output device 206.

FIG. 9D is a diagram illustrating an example of a screen 931 for the display data output to the output device 206. The screen 931 includes partial data 933 obtained by partially enlarging the superimposition data 921. The screen 931 also includes a label type 934 to be displayed, an image resolution level 935 of the partial data 933, and a display scale factor 936 of the partial data. This allows the user to easily grasp the label type and the display resolution of the displayed image. Further, as the method of displaying the resolution of the image, information other than the resolution level may be displayed. For example, a resolution value 941 may be displayed as illustrated in FIG. 9E, or a display mode 951 including two levels of high resolution and low resolution may be displayed as illustrated in FIG. 9F. In a case where the resolution value 941 is displayed, a value of the resolution of the image used for creating the display data is acquired at the time of creating the display data.

### <Step S406: Determination on Whether Processing Has Ended>

In step S406, the control unit 201 determines whether all processing according to the present exemplary embodiment has ended.

In a case where all processing according to the present exemplary embodiment has ended (YES in step S406), the processing ends. In contrast, in a case where the control unit 201 receives user operation to change a display setting of the display data via the input device 205, it is necessary to continue the processing. In such a case where the control unit 201 receives user operation to change a display setting for the display data (NO in step S406), the processing proceeds to step S407.

### <Step S407: Change of Display Setting for Display Data>

In step S407, the control unit 201 receives a user operation instruction to change the display setting of the display data via the input device 205. As a method of changing the display setting, for example, a change of the display range, a change of the display scale factor, a change of the label type to be displayed, and change of the resolution can be considered.

For example, in step S407, the control unit 201 receives the user operation instruction to change the selection state of the label type 934 and to select two types of “reinforcing bar exposure” and “water leakage” in the screen 931 illustrated in FIG. 9D. In this case, in the present exemplary embodiment, after the user operation instruction is received, the processing returns to step S403, and the label data acquisition unit 225 acquires new label data. Thereafter, in step S405 after the processing in step S404, the display control unit 227 regenerates the display data, and outputs the display data to the output device 206.

In the above-described example, in a case where the user operation instruction to change the resolution level is received in the screen 931 illustrated in FIG. 9D, it is unnecessary to newly acquire the label data. Therefore, the processing may return to step S404. In step S404, the image selection unit 226 selects the processed image corresponding to the resolution level selected by the user operation instruction. In step S405, the display control unit 227 regenerates the display data, and outputs the display data to the output device 206.

Further, in a case where the user operation instruction to change the display range or the display scale factor is received in the screen 931 illustrated in FIG. 9D, it is unnecessary to newly acquire the label data or to select the image. Therefore, the processing may return to step S405. Then, in step S405, the display control unit 227 generates the display data by changing the display range or the display scale factor of the superimposition data, and outputs the display data to the output device 206. In this manner, the processing for updating the display data is performed upon receiving the operation to change the display setting of the display data, which makes it possible to update the display data.

### <Modification Example of First Exemplary Embodiment>

In the present exemplary embodiment, the display control unit performing the display data creation processing and the display data display processing may be configured by another information processing apparatus via a network. More specifically, the information processing apparatus including the display control unit acquires the processed image selected in step S404 and the label data acquired in step S403 by data communication via the network. Further, the information processing apparatus generates the display data by using the acquired processed image and label data, and outputs the display data to a display device. In this case, the image of the suitable resolution can also be selected based on the defect type to be checked. This makes it possible to reduce the data communication load.

In the present exemplary embodiment, the image of the suitable resolution is selected based on the defect type when the defect detection result is checked; however, as an image for detection used in the defect detection processing, the target image may be selected. More specifically, a plurality of processed images different in resolution is generated from the image obtained by imaging an inspection object. Then, the image of the suitable resolution is selected based on the defect type to be detected, and the defect detection processing is performed. In this manner, the detection processing can be performed using the image of the suitable resolution based on the defect type. This makes it possible to efficiently perform the detection processing.

In the present exemplary embodiment, the example in which the defect detection result of the image obtained by imaging an inspection object in infrastructure inspection is checked as an object to be checked in the image is described; however, the present exemplary embodiment is applicable to an object other than the defect. For example, the present exemplary embodiment is applicable to a checking work in medical diagnosis to check for a lesion (object) from a captured image of a human body (inspection object) in a hospital and the like. More specifically, a plurality of lesions is detected from a captured image of a human body by using artificial intelligence (AI). Further, a plurality of processed images different in resolution is generated based on the captured image, and the image of the suitable resolution is selected based on a type of a lesion to be checked. Detected lesion data and the selected image are superimposed, and display data is displayed. An image of a suitable resolution is selected based on the type of the lesion in the above-described manner, which makes it possible to perform lightweight display processing. The image is not necessarily limited to an image optically captured, and may be, for example, vector data.

As described above, according to the present exemplary embodiment, the image of the suitable resolution is selected based on the label type to be checked, the display data is generated by superimposing the label data and the processed image, and the display data is displayed on the display unit. This makes it possible to reduce the data readout load and the communication load.

In the first exemplary embodiment, the example in which, when the defect detection result is displayed, the image of the suitable resolution is selected and displayed based on the defect type is described. At this time, when a combination of the label data on a crack and the like and the image is collected and used as training data to be used for machine learning and deep learning, improvement in defect detection performance can be expected. In a case where training is performed with a minute defect such as a crack, an image of a high resolution is desirably collected as the training data. In contrast, in a case of a defect occurring in a wide region such as water leakage, collection of an image of a low resolution is sufficient because such a defect can be visually recognized on an image reduced to the low resolution. As described above, the image of the suitable resolution is collected as the training data based on the defect type to be trained, which makes it possible to suppress an increase in size of the training data. Therefore, in a second exemplary embodiment, a description is given of a method of selecting and collecting an image of a suitable resolution based on a defect type in collecting the training data to improve detection performance of a detector that detects a defect such as a crack from an image of a wall surface of a concrete structure.

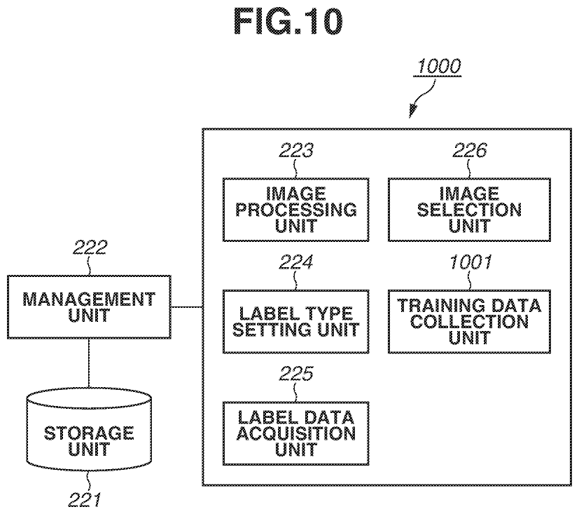

A hardware configuration of an information processing apparatus according to the present exemplary embodiment is similar to the hardware configuration according to the first exemplary embodiment illustrated in FIG. 2A. Therefore, description thereof is omitted. FIG. 10 is a block diagram illustrating a functional configuration example of an information processing apparatus 1000 according to the present exemplary embodiment. The functional configuration illustrated in FIG. 10 is different from the functional configuration illustrated in FIG. 2B described in the first exemplary embodiment in that a training data collection unit 1001 is added in place of the display control unit 227.

The training data collection unit 1001 is a functional unit of the control unit 201, and performs processing for collecting a combination of the label data and the processed image as training data. In the present exemplary embodiment, the label type setting unit 224 performs processing for setting the label type to be trained, and the label data acquisition unit 225 performs processing for acquiring label data to be trained.

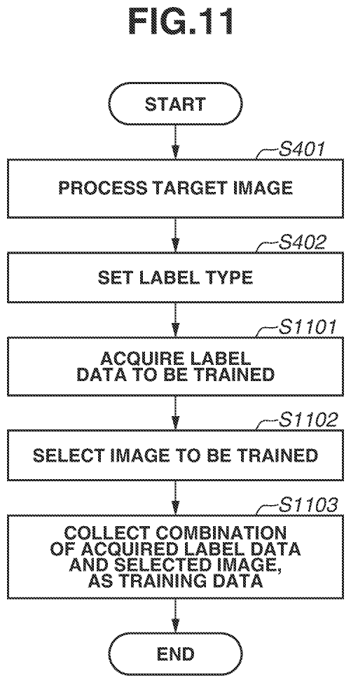

FIG. 11 is a flowchart illustrating an example of a processing procedure performed by the information processing apparatus 1000 according to the present exemplary embodiment. In the flowchart illustrated in FIG. 11, in steps denoted by the same step numbers as in the flowchart illustrated in FIG. 4 described in the first exemplary embodiment, processing similar to the processing in the first exemplary embodiment is performed. Therefore, description thereof is omitted. In the present exemplary embodiment, after the label type setting unit 224 sets the label type to be trained in step S402, the processing proceeds to step S1101. In step S1101, the label data acquisition unit 225 performs processing for acquiring label data to be trained. In step S1102, the image selection unit 226 selects an image to be trained from the processed images. In step S1103, the training data collection unit 1001 collects a combination of the selected label data and the processed image as the training data. An outline of the processing in steps S1101, S1102, and S1103 is described below.

### <Step S1101: Label Data Acquisition Process>

In step S1101, the label data acquisition unit 225 performs the processing for acquiring label data to be trained. In the present exemplary embodiment, the label data acquisition unit 225 acquires the defect data stored in the storage unit 221 as the label data via the management unit 222.

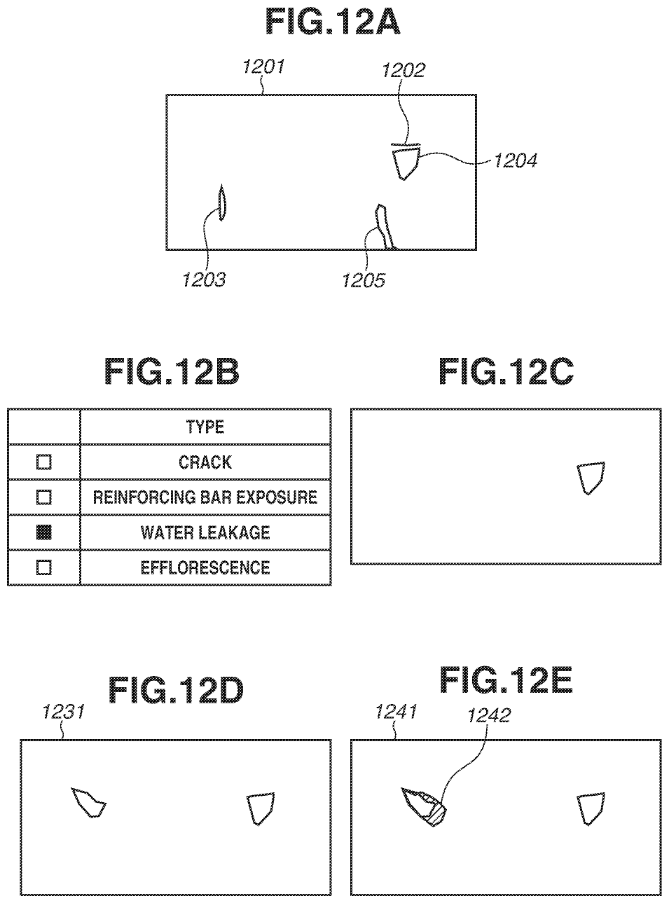

FIG. 12A is a diagram illustrating an example of defect data 1201 relating to the target image. The defect data 1201 includes crack data 1202, reinforcing bar exposure data 1203, water leakage data 1204, and efflorescence data 1205. The label data acquisition unit 225 acquires, as the label data, defect data corresponding to the detection result of the label type to be trained from the defect data 1201. For example, in a case where “water leakage” is selected as the label type to be trained as illustrated in FIG. 12B, the label data acquisition unit 225 acquires the water leakage data 1204 as the label data. FIG. 12C illustrates an acquisition result of the label data to be trained.

Defect data generated by the detection processing using AI and the like may include erroneous detection and non-detection in some cases. Therefore, a work of correcting the erroneous detection and the non-detection is performed by the user. The defect data corrected by the work is highly likely to be defect data with a high training effect. Therefore, it is desirable that the defect data corrected by the work is preferentially selected as the label data to be trained. A method of selecting the defect data with the high training effect is described with reference to FIGS. 12D and 12E.

FIG. 12D is a diagram illustrating an example of defect data 1231 generated using AI and the like, and FIG. 12E is a diagram illustrating an example of defect data 1241 obtained by correcting the defect data 1231 by the user. In the defect data 1241, a hatched region 1242 is a region where an updated portion of the defected data is visualized. The defect data 1231 generated by AI and the like is updated in advance by a work of the user to the defect data 1241 including the hatched region 1242, and the defect data 1241 is stored in the storage unit 221. The label data acquisition unit 225 preferentially acquires the corrected defect data as the label data to be trained. A defect data update history is stored together with the defect data in the storage unit 221. Therefore, the label data acquisition unit 225 can acquire the defect data and the defect data update history via the management unit 222.

When the label data is acquired using the defect data update history, in a case where the number of pieces of updated defect data is large, the label data to be acquired is desirably narrowed down. For example, an update amount (e.g., updated length, updated area, number of changed labels, number of update operations, and update work time) of each piece of defect data is calculated based on the defect data update history. Thereafter, the plurality of pieces of defect data is acquired as the label data in descending order of the calculated update amount. In this manner, the defect data having the large update amount can be preferentially acquired as the training object. In a case where the label data to be acquired is narrowed down based on the defect data update history, the priority order of the label data to be acquired may be determined by combining a plurality of types of update histories.

As another method of acquiring the label data to be trained, a screen for receiving a user operation instruction may be displayed to prompt the user to select the label data to be acquired. For example, the defect data associated with the label type to be trained is displayed on the screen, and the label data acquisition unit 225 acquires the defect data selected on the screen by the user operation instruction, as the label data to be trained. To perform training with part of a large amount of defect data, the method of receiving the user operation instruction in the above-described manner is preferably used.

### <Step S1102: Image Selection Process>

In step S1102, the image selection unit 226 performs the processing for acquiring the processed image to be trained from the processed images. In the present exemplary embodiment, a method of selecting, based on the label type to be trained, the image of the suitable resolution from the images different in resolution generated in step S401 is described.

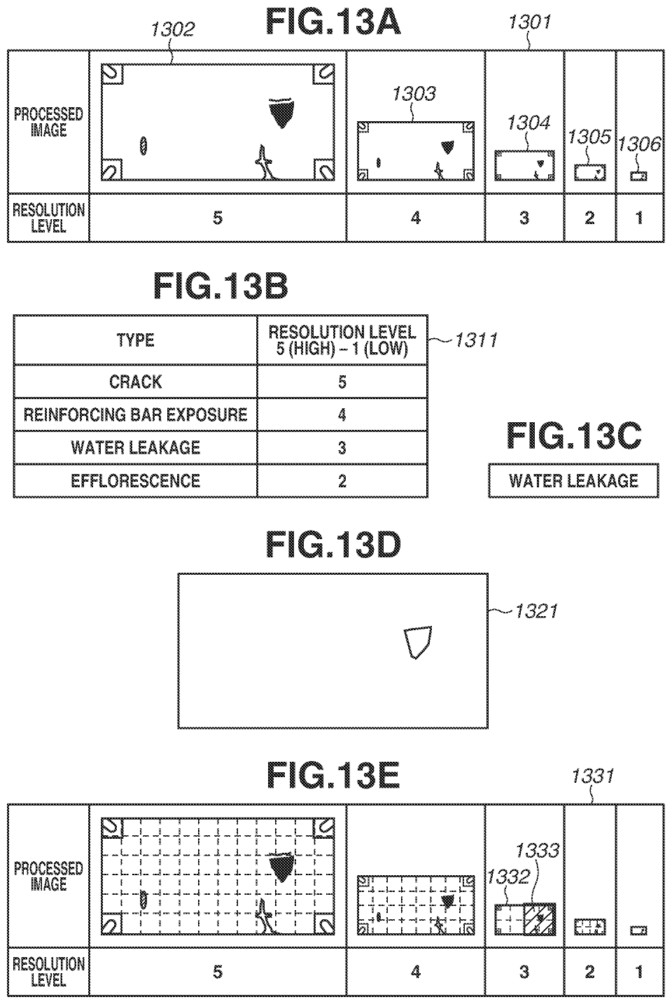

FIG. 13A is a diagram illustrating an example of processed images 1301 generated in step S401. The image selection unit 226 selects the image of the suitable resolution from processed images 1302 to 1306 by using a resolution level list 1311 indicated by label type illustrated in FIG. 13B. The resolution level list 1311 is similar to the resolution level list 811 illustrated in FIG. 8B. In a case where “water leakage” is set as the label type to be trained as illustrated in FIG. 13C, the image selection unit 226 selects the processed image 1304 corresponding to the resolution level 3.

Further, in the processing performed by the image selection unit 226, an actual resolution value may be used in place of the resolution level list 1311 illustrated in FIG. 13B. In this case, as the resolution for each of the label types, an actual resolution value (e.g., 1.0 mm/pixel) is set, and resolutions of the processed images are also acquired. Thus, based on the actual resolution value corresponding to the label type, the image of the suitable resolution can be selected from the processed images.

In the processing performed by the image selection unit 226, the label type to be trained and the label data to be trained may be combined to select a partial image of the resolution corresponding to the label type. For example, it is assumed that, in step S1101, label data 1321 to be trained illustrated in FIG. 13D is acquired. The label data 1321 is label data acquired in the case where “water leakage” corresponding to the resolution level 3 is selected as the label type to be trained. FIG. 13E is a diagram illustrating an example of processed images 1331 subjected to the image dividing processing in step S401. At this time, the image selection unit 226 selects a partial image (e.g., partial image 1333) including a region corresponding to the water leakage data in the label data 1321, from an image 1332 corresponding to the resolution level 3. In this manner, selecting the partial image of the region including the label data to be trained makes it possible to intensively collect the training data including the label data in training data collection processing described below.

### <Step S1103: Training Data Collecting Process>

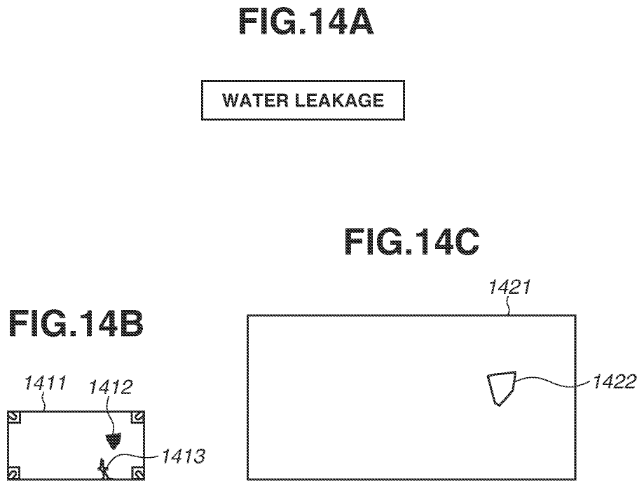

In step S1103, the training data collection unit 1001 collects the combination of the selected label data and the selected processed image as the training data. In the following description of the training data collection processing according to the present exemplary embodiment, it is assumed that that “water leakage” is set as the label type to be trained as illustrated in FIG. 14A.

FIG. 14B is a diagram illustrating an example of a processed image 1411 selected by the image selection unit 226.

The processed image 1411 is an image obtained by performing reduction processing on the original image, and water leakage 1412 and efflorescence 1413 are confirmed in the image. FIG. 14C is a diagram illustrating an example of label data 1421 acquired by the label data acquisition unit 225, and water leakage data 1422 is included. The training data collection unit 1001 performs processing for collecting a combination of the processed image 1411 and the label data 1421 as the training data. In a case where the partial image 1333 is selected by the image selection unit 226 as illustrated in FIG. 13E, a combination of the partial image and the label data is collected as the training data.

As described with reference to FIGS. 3A to 3C, each of the label data and the processed image to be collected has the coordinate values in the drawing coordinate system. Therefore, coordinate values on the processed image 1411 can be indirectly determined. Thus, the processed image 1411 and the label data 1421 can be used as the training data after adjusting scales and positional relationship of the processed image 1411 and the label data 1421.

### <Modification Example of Second Exemplary Embodiment>

In the present exemplary embodiment, the image collected together with the label data as the training data may be a generated image. For example, a plurality of processed images different in resolution is generated for defect detection processing in advance, and is stored in the storage unit 221. Thereafter, in the training data collection processing according to the present exemplary embodiment, in place of creation of the processed image by the image processing unit 223 in step S401, the generated processed image stored in the storage unit 221 may be acquired via the management unit 222. This makes it possible to omit the image processing for collecting the training data, and to further improve efficiency of the processing.

As described above, according to the present exemplary embodiment, the combination of the image of suitable resolution and the label data can be collected as the training data based on the label type. This makes it possible to suppress an increase in the amount of the training data.

### Other Exemplary Embodiments

The present disclosure can be implemented by supplying programs for implementing one or more functions of the above-described exemplary embodiments to a system or an apparatus via a network or a storage medium, and causing one or more processors in a computer of the system or the apparatus to read out and execute the programs. Further, the present disclosure can be implemented by a circuit (e.g., an application specific integrated circuit (ASIC)) for implementing one or more functions.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-070796, filed Apr. 24, 2023, which is hereby incorporated by reference herein in its entirety.

What is claimed is:

1. An information processing apparatus, comprising:
one or more memories storing instructions; and
one or more processors executing the instructions to:
generate a plurality of processed images different in resolution, from a target image;
set a type of an object included in the target image; and
select, as an image to be used for specifying the object of the type that has been set, from the plurality of processed images, a processed image of a resolution corresponding to the type of the object that has been set.

2. The information processing apparatus according to claim 1, wherein execution of the stored instructions further configures the one or more processors to cause a display of display data on a display unit to check the object of the type that has been set by using the selected processed image.

3. The information processing apparatus according to claim 2, wherein execution of the stored instructions further configures the one or more processors to:
acquire a detection result of the object of the type that has been set and which is included in the target image; and
generate the display data based on the selected processed image and the acquired detection result and cause the display unit to display the display data.

4. The information processing apparatus according to claim 2, wherein execution of the stored instructions further configures the one or more processors to:
generate the plurality of processed images by preforming resolution conversion processing and image dividing processing in combination;
select a partial image based on sections divided by the image dividing processing from the selected processed image; and
generate the display data by using the partial image and cause the display unit to display the display data.

5. The information processing apparatus according to claim 2, wherein execution of the stored instructions further configures the one or more processors to, in a case where a plurality of types is set, select a processed image of a resolution corresponding to a type associated with a highest resolution among the plurality of set types.

6. The information processing apparatus according to claim 2, wherein the display data includes at least a resolution of the selected processed image or the set type of the object.

7. The information processing apparatus according to claim 6, wherein execution of the stored instructions further configures the one or more processors to:
receive an operation to change the resolution of the displayed processed image or the type of the object;
in a case where the operation to change the resolution is received, select a processed image of a changed resolution; and
in a case where the operation to change the type of the object, set a changed type.

8. The information processing apparatus according to claim 1, wherein execution of the stored instructions further configures the one or more processors to:
acquire a detection result of the object of the set type included in the target image; and
collect a combination of the selected processed image and the acquired detection result as training data.

9. The information processing apparatus according to claim 8, wherein execution of the stored instructions further configures the one or more processors to select and acquire the detection result of the object based on a detection result update history.

10. The information processing apparatus according to claim 8, wherein execution of the stored instructions further configures the one or more processors to:
generate the plurality of processed images by performing resolution conversion processing and image dividing processing in combination;
select a partial image based on sections divided by the image dividing processing from the selected processed image; and
collect a combination of the partial image and the acquired detection result as training data.

11. The information processing apparatus according to claim 1, wherein execution of the stored instructions further configures the one or more processors to select the processed image as an image to be used for detecting the object included in the target image.

12. An information processing method, comprising:
generating a plurality of processed images different in resolution, from a target image;
setting a type of an object included in the target image; and
selecting, as an image to be used for specifying the object of the type that has been set, from the plurality of processed images, a processed image of a resolution corresponding to the type of the object that has been set.

13. A non-transitory computer-readable storage medium that stores a program for causing an information processing apparatus to perform a control method, the control method comprising:
generating a plurality of processed images different in resolution, from a target image;
setting a type of an object included in the target image; and
selecting, as an image for specifying the object of the type that has been set, from the plurality of processed images, a processed image of a resolution corresponding to the type of the object that has been set.
